(19) United States
(12) Patent Application Publication
(10) Pub. No.: US 2025/0119226 A1
(43) Pub. Date: Apr. 10, 2025

(54) SUBSCRIBER LINE ACCOMMODATING DEVICE, TESTING SYSTEM, TESTING METHOD, AND TESTING PROGRAM

(71) Applicant: Nippon Telegraph and Telephone Corporation, Tokyo (JP)

(72) Inventors: Noriyuki Sato, Musashino-shi, Tokyo (JP); Takayuki FURUYA, Musashino-shi, Tokyo (JP)

(21) Appl. No.: 18/293,450

(22) PCT Filed: Aug. 20, 2021
(86) PCT No.: PCT/JP2021/030531

§ 371 Date: Jan. 30, 2024

(51) Int. Cl. H04J 3/14

(52) U.S. Cl. CPC H04J 3/14

(57) ABSTRACT

A subscriber line accommodation device (2) includes a mounting unit (21) capable of mounting a plurality of line termination units (20). The mounting unit (21) includes a communication line for the plurality of line termination units (20) to communicate a test signal with a time difference by a time division multiplex transmission method, and a timing line (SCK) for causing the plurality of line termination units (20) to receive a communication timing of the test signal in the time division multiplex transmission method, and the test signal is communicated with at least one line termination unit (20) connected to the same communication line to test normality of the same communication line, and the communication timing is received by at least one line termination unit (20) connected to the same timing line (SCK) to test normality of the same timing line (SCK).

### TECHNICAL FIELD

The present invention relates to a subscriber line accommodation device, a test system, a test method, and a test program.

### BACKGROUND ART

A subscriber line accommodation device accommodates a plurality of subscriber terminals outside the device via a plurality of Integrated Services Digital Network (ISDN) lines (subscriber lines). When a communication problem occurs, a maintenance engineer monitors a voice signal or a data signal flowing on the ISDN line to isolate a malfunctioning portion.

An ISDN multi-line analyzer described in Non Patent Literature 1 monitors eight ISDN lines with one monitoring device. Accordingly, it is possible to save space as compared with a case where one ISDN line is monitored with one monitoring device.

### CITATION LIST

### Non Patent Literature

Non Patent Literature 1: NTT EAST, “Sekai de yuiitsu no 8 kaisen douji monita tsuwa rokuon ga kanona ‘ISDN takaisen anaraiza’ no kaihatsu (in Japanese) (Development of the world's only ‘ISDN multi-line analyzer’ capable of simultaneous monitoring and recording of 8 lines)”, NTT Technical Journal 2018. 1, p. 47-50

### SUMMARY OF INVENTION

### Technical Problem

There is also a configuration including a mounting unit capable of mounting a plurality of line termination units in one subscriber line accommodation device. The mounting unit has slots to and from which individual line termination units can be attached and detached, and wiring for communicating with an external host device is deployed in each slot.

In this way, the type and the number of line termination units to be mounted can be flexibly changed by including the mounting unit in the subscriber line accommodation device, and the communication service can be easily changed.

Here, in a case where a problem occurs in the subscriber line accommodation device, the cause of the problem may be failure of individual line termination units to be mounted, or failure (disconnection) of a wiring portion of a mounting unit to be mounted even when individual line termination units are normal. That is, it is necessary to test normality of the mounting unit of the subscriber line accommodation device as well.

Therefore, the maintenance engineer actually mounts all the line termination units that can be mounted on the mounting unit in the subscriber line accommodation device in which the problem has occurred, and externally connects the subscriber terminals from the line termination units. Accordingly, the normality of the mounting unit is tested by monitoring the subscriber line with a conventional monitoring device such as that in Non Patent Literature 1.

However, in such a test method in which all the line termination units are actually mounted, complicated work such as attachment/detachment work of the line termination units and connection work of the subscriber terminals increases, and the workload and the working time become a large burden.

Therefore, a main object of the present invention is to reduce a burden of a test on a mounting unit of a subscriber line accommodation device on which a plurality of line termination units are mounted.

### Solution to Problem

In order to solve the above problems, a subscriber line accommodation device of the present invention has the following features.

The present invention provides a subscriber line accommodation device including a mounting unit capable of mounting a plurality of line termination units,
the mounting unit includes a communication line for the plurality of line termination units to communicate a test signal with a time difference by a time division multiplex transmission method, and a timing line for causing the plurality of line termination units to receive a communication timing of the test signal in the time division multiplex transmission method, and
the test signal is communicated with at least one of the line termination units connected to the same communication line to test normality of the same communication line, and the communication timing is received by at least one of the line termination units connected to the same timing line to test normality of the same timing line.

### Advantageous Effects of Invention

According to the present invention, it is possible to reduce a burden of a test on a mounting unit of a subscriber line accommodation device on which a plurality of line termination units are mounted.

### BRIEF DESCRIPTION OF DRAWINGS

FIG. 1 is a configuration diagram of a test system according to the present embodiment.

FIG. 2 is a hardware configuration diagram of each device constituting the test system according to the present embodiment.

FIG. 3 is a layout diagram of a mounting unit in a subscriber line accommodation device according to the present embodiment.

FIG. 4 is a layout diagram in which wiring for connecting to a host device is added to the layout diagram of FIG. 3 according to the present embodiment.

FIG. 5 is an explanatory diagram of a timing clock transmitted via a timing line according to the present embodiment.

FIG. 6 is a table illustrating combinations for executing a first test for devices of a first set indicated by solid thick lines in FIG. 3 according to the present embodiment.

FIG. 7 is a sequence diagram illustrating details of a test of ID=T1 in FIG. 6 according to the present embodiment.

### DESCRIPTION OF EMBODIMENTS

Hereinafter, an embodiment of the present invention will be described in detail with reference to the drawings.

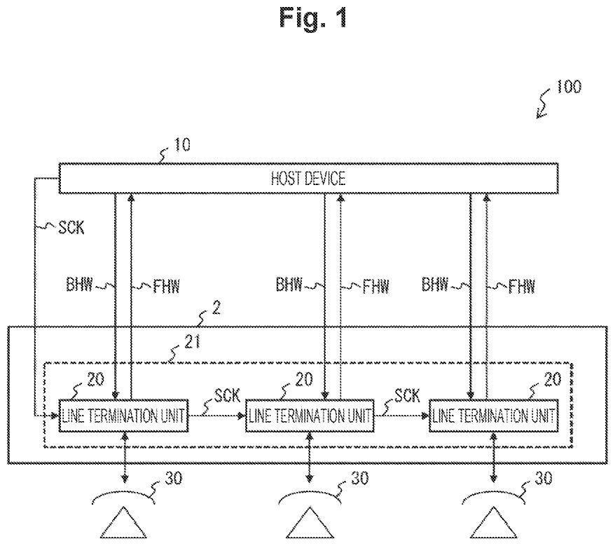

FIG. 1 is a configuration diagram of a test system 100.

The test system 100 is configured by connecting a host device 10, a subscriber line accommodation device 2, and a subscriber terminal 30 via a network.

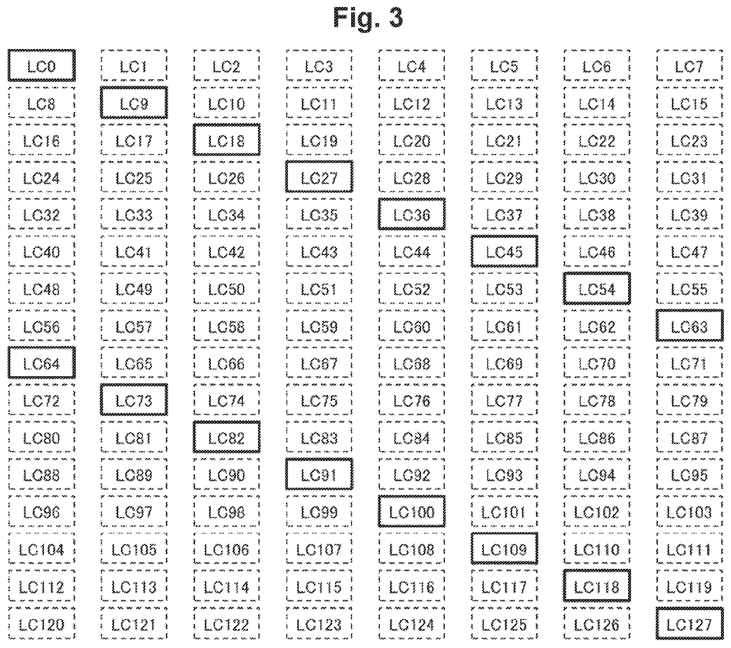

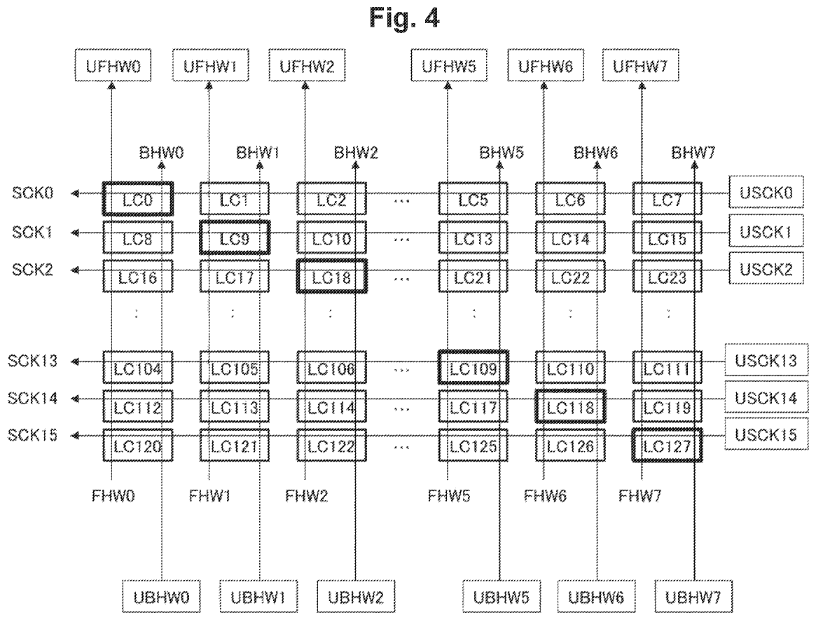

One subscriber line accommodation device 2 includes a mounting unit 21 capable of mounting a plurality of line termination units 20 therein. The mounting unit 21 has slots to and from which the individual line termination units 20 can be attached and detached, and wiring (a transmission line FHW, a reception line BHW, and a timing line SCK) for communicating with the external host device 10 is deployed in each slot. Here, each wiring in FIG. 1 is merely a simple illustration for describing the outline of the test system 100, and a specific wiring layout will be described in detail with reference to FIGS. 3 and 4.

Note that the line termination unit 20 mounted on the mounting unit 21 may be a line termination device that accommodates the subscriber terminal 30 of the ISDN terminal via an ISDN line (a subscriber line), or may be a subscriber circuit that accommodates the subscriber terminal 30 such as an analog phone or a modem via a telephone line (a subscriber line). The line termination unit 20 is connected to the subscriber terminal 30 via a subscriber line which is a two-wire metal line.

The reception line BHW and the timing line SCK are used by the line termination unit 20 to receive a control signal for controlling the operation of the line termination unit 20 from the host device 10. Specifically, the line termination unit 20 receives a timing clock (a control signal) from the host device 10 via the timing line SCK to ascertain a timing at which the test signal is transmitted and received. Then, the line termination unit 20 receives the test signal from the host device 10 via the reception line BHW according to the timing clock.

The transmission line FHW is used to transmit a control signal for notifying the host device 10 of the state of the line termination unit 20 from the line termination unit 20. Specifically, the line termination unit 20 transmits a response to the received test signal (hereinafter referred to as a “response signal”) via the transmission line FHW according to the timing clock.

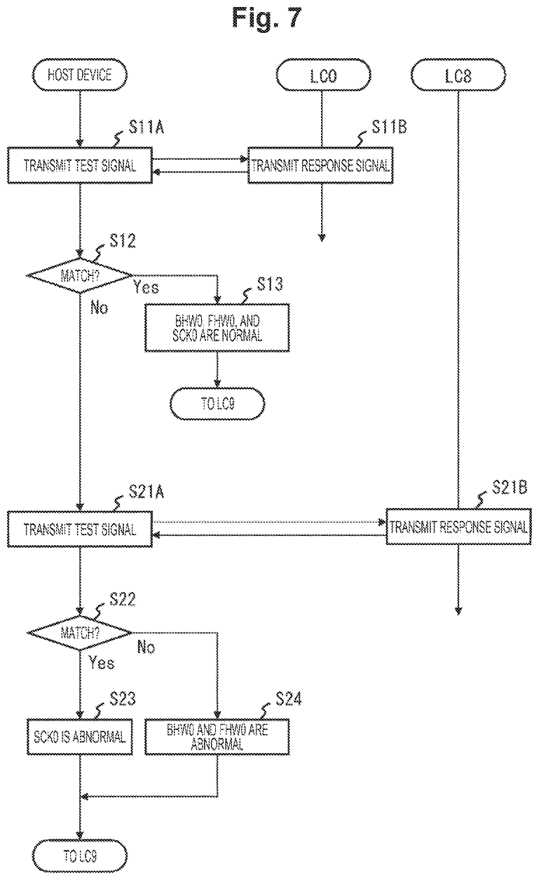

The host device 10 checks normality of the wiring connected to the predetermined line termination unit 20 in the mounting unit 21 by collating the test signal transmitted to the predetermined line termination unit 20 with the response signal received from the predetermined line termination unit 20 (details are illustrated in FIG. 7).

The timing clock determines the timing at which each line termination unit 20 transmits and receives the test signal when the plurality of line termination units 20 are connected to a pair of transmission and reception lines (the transmission line FHW and the reception line BHW). That is, each line termination unit 20 can transmit and receive the test signal with a time difference without data collision on the pair of transmission and reception lines shared with other line termination units 20 by a time division multiplex transmission method according to the timing clock.

Here, by utilizing a loopback function of the line termination unit 20 or the subscriber terminal 30, a response signal to the test signal transmitted from the host device 10 to the line termination unit 20 is automatically generated and returned to the host device 10.

First, in a case where a line termination device that accommodates an ISDN line is used as the line termination unit 20, a loopback function of the line termination device or a loopback function of the subscriber terminal 30 (digital service unit: DSU) tests normality of a communication line by looping back a received test signal with no error, even of 1 bit.

On the other hand, in a case where a subscriber circuit that accommodates a telephone line is used as the line termination unit 20, the loopback function of the subscriber circuit or the loopback function of the subscriber terminal 30 (modem) tests the normality of the communication line by looping back the received test signal. The loopback function of the subscriber circuit is executed in the order of data reception of a test signal→voice conversion (D/A)→data conversion (A/D)→data transmission of a response signal.

Note that, by utilizing the loopback function inside the line termination unit 20, it is possible to omit time and effort for connecting the subscriber terminal 30 to the line termination unit 20.

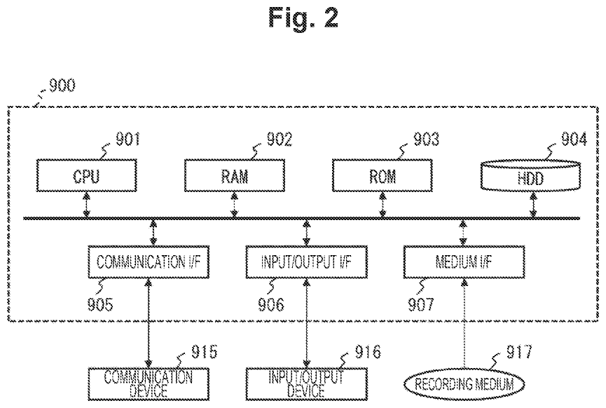

FIG. 2 is a hardware configuration diagram of each device (the subscriber line accommodation device 2 and the host device 10) constituting the test system 100.

Each device constituting the test system 100 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. Moreover, the CPU 901 controls each processing unit by executing a program (also referred to as an application or an app for abbreviation thereof) read into the RAM 902. Then, the program can be distributed via a communication line or recorded in the recording medium 917 such as a CD-ROM and distributed.

FIG. 3 is a layout diagram of the mounting unit 21 in the subscriber line accommodation device 2. FIG. 3 illustrates an example of the mounting unit 21 capable of arranging 128 line termination units 20 (devices LC0 to LC127) in a lattice shape in one subscriber line accommodation device 2.

FIG. 4 is a layout diagram in which wiring for connection to the host device 10 is added to the layout diagram of FIG. 3. In FIG. 4, a description will be given by extracting a part from the line termination unit 20 in FIG. 3.

A total of eight reception lines BHW0 to 7 are wiring for each line termination unit 20 to receive a test signal from the host device 10. Starting points (transmission sources) of the reception lines BHW0 to 7 are transmission elements UBHW0 to 7 in the host device 10.

A total of eight transmission lines FHW0 to 7 are wiring for each line termination unit 20 to transmit a response signal to the host device 10. Ending points (transmission destinations) of the transmission line FHW0 to 7 are reception elements UFHW0 to 7 in the host device 10.

A total of 16 timing lines SCK0 to 15 are wiring for each line termination unit 20 to receive a timing clock from the host device 10. Starting points (transmission sources) of the timing line SCK0 to 15 are timing elements USCK0 to 15 in the host device 10.

Therefore, it is desirable that the test of the mounting unit 21 cover the test of the wiring sections (the transmission lines FHW0 to 7, the reception lines BHW0 to 7, and the timing lines SCK0 to 15) connected to each line termination unit 20 and the test of the communication elements (the reception elements UFHW0 to 7, the transmission elements UBHW0 to 7, and the timing elements USCK0 to 15) on the host device 10 side, which is the other end point of those wiring sections.

Referring back to FIG. 3, 16 line termination units 20 connected by the same transmission and reception line are arranged in one column in one direction (vertical direction) of the lattice shape. For example, 16 devices LC0, LC8, . . . , and LC120 connected by the same transmission and reception line (the transmission line FHW0 and the reception line BHW0 in FIG. 4) are arranged in the first column of the lattice shape.

In the other direction (horizontal direction) of the lattice shape of FIG. 3, eight line termination units 20 connected by the same timing line SCK are arranged in one row. For example, eight devices LC0 to LC7 connected by the same timing line SCK0 (FIG. 4) are arranged in the first row of the lattice shape.

In this manner, one transmission line FHW, one reception line BHW, and one timing line SCK illustrated in FIG. 4 are connected to each of the devices LC0, LC1, . . . , LC126, and LC127 in FIG. 3. For example, the transmission line FHW1, the reception line BHW1, and the timing line SCK1 are connected to the device LC9.

Note that a pair of transmission and reception lines (for example, the transmission line FHW0 and the reception line BHW0) having the same last single-digit number (0 to 7) are connected to a set of line termination units 20 (for example, 16 devices LC0, LC8, . . . , and LC120 located in the first column of FIG. 3) having the same column in FIG. 3.

The 16 devices LC0, LC8, . . . , and LC120 are connected to the same transmission and reception line (the transmission line FHW0 and the reception line BHW0) in order to communicate a test signal with a time difference by the time division multiplex transmission method. At least one line termination unit 20 communicates a test signal via the transmission and reception line, whereby the normality of the transmission and reception line is tested.

In addition, the timing lines SCK0 to 15 is connected to eight devices located in each row of FIG. 3. For example, the eight devices LC0, LC1, . . . , and LC7 in the first row of FIG. 3 are connected to the same timing line SCK0. At least one line termination unit 20 receives the timing clock via the timing line SCK0, whereby the normality of the timing line SCK0 is tested.

In FIG. 3, devices LC0, LC9, . . . LC63, LC64, . . . , and LC127 of a first set indicated by solid thick lines and devices LC1, LC2, . . . and LC126 of a second set indicated by other wavy thin lines are distinguished. The first set is a first test target, and the second set is the next test target when an abnormality is confirmed in the first set.

Accordingly, in a case where all the test targets of the first test are normal, the test of the second set can be omitted, and therefore the number of tests can be simplified to 16, which is the number of elements of the first set, as compared with a method in which the number of tests is executed in all combinations (128 times in total of LC0 to LC127). That is, 112 times of the second set can be omitted.

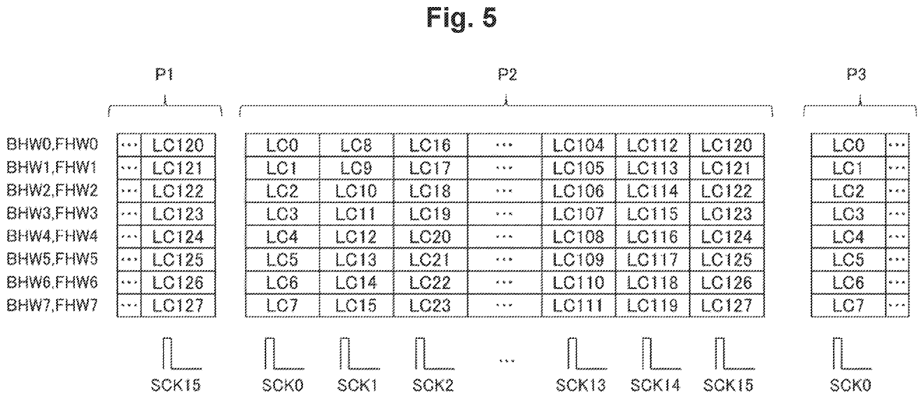

FIG. 5 is an explanatory diagram of a timing clock transmitted via the timing lines SCK0 to 15. In this explanatory diagram, time elapses as it goes to the right side of the paper surface.

In each of frames P1, P2, and P3, the timing clock is transmitted to the line termination unit 20 of the connection destination once with a time difference in the order of the timing lines SCK0, SCK1, . . . , and SCK15. Each line termination unit 20 transmits and receives the test signal at the point of time of the received timing clock according to the time division multiplex transmission method (see Examples 1 to 3 below).

(Example 1) By receiving the timing clock of the timing line SCK0, the device LC0 receives the test signal from the reception line BHW0, and transmits the response signal from the transmission line FHW0 at the same timing clock (by full-duplex communication). Similarly, the devices LC1 to 7 also receive the test signals from the reception lines BHW1 to 7 by the timing clock of the timing line SCK0, and transmit the response signals from the transmission lines FHW1 to 7 at the same timing clock.

(Example 2) By receiving the timing clock of the timing line SCK1, the device LC8 receives the test signal from the reception line BHW0, and transmits the response signal from the transmission line FHW0 at the same timing clock. Similarly, the devices LC9 to 15 also receive the test signals from the reception lines BHW1 to 7 by the timing clock of the timing line SCK1, and transmit the response signals from the transmission lines FHW1 to 7 at the same timing clock.

(Example 3) The same applies to the timing clock of the timing line SCK2 to the timing clock of the timing line SCK15. For example, by receiving the timing clock of the timing line SCK15, the devices LC120 to 127 receive the test signals from the reception lines BHW0 to 7, and transmit the response signals from the transmission lines FHW0 to 7 at the same timing clock.

That is, when i=0 to 15 and j=0 to 7, by receiving the timing clock of the timing line SCKi, the device LC (i*8+j) receives the test signal from the reception line BHWj, and transmits the response signal from the transmission line FHWj at the same timing clock.

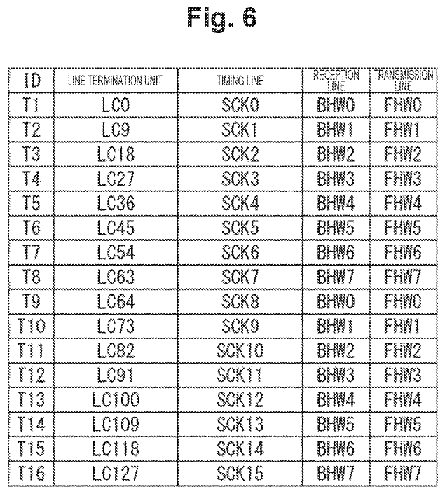

FIG. 6 is a table illustrating combinations for executing the first test for each of the devices LC0, LC9, . . . , LC63, LC64, . . . , and LC127 of the first set indicated by the solid thick lines in FIG. 3.

This table shows, for each ID of the test, the line termination unit 20 as a test target (a device group highlighted by the solid thick lines in FIG. 3) and a combination of the wirings (the timing line SCK, the reception line BHW, and the transmission line FHW) connected to the line termination unit 20.

For example, when ID=T1, the device LC0 executes a process of reading the test signal from the reception line BHW0 and a process of transmitting the response signal to the transmission line FHW0 based on the timing clock indicated by the timing line SCK0.

When the collation result between the test signal and the response signal matches (for example, is consistent), the host device 10 determines that the test result of the device LC0 is normal, and determines that the combination of the wirings (the timing line SCK0, the reception line BHW0, and the transmission line FHW0) connected to the device LC0 is also normal (not disconnected). That is, by the test of ID=T1, not only the normality of the timing line SCK0 but also the normality of the reception line BHW0 and the normality of the transmission line FHW0 can be checked.

Similarly, at ID=T2, by checking the normality of the device LC9, not only the normality of the timing line SCK1 connected to the device LC9 but also the normality of the reception line BHW1 and the normality of the transmission line FHW1 can be checked.

Here, the line termination unit 20 as a test target is selected such that the reception line BHW0 with ID=T1 and the reception line BHW1 with ID=T2 have different wirings. Similarly, the line termination unit 20 as a test target is selected such that the transmission line FHW0 with ID=T1 and the transmission line FHW1 with ID=T2 have different wirings.

In this way, when the normality of the different timing lines SCK is checked, it is desirable to check the devices LC connected to the different transmission lines FHW and reception lines BHW as the devices LC on the timing lines SCK. Accordingly, in the process of checking the normality of all the timing lines SCK0 to SCK15, the number of times of checking can be reduced by also serving as the process of checking the normality of all the transmission lines FHW0 to 7 and the process of checking the normality of all the reception lines BHW0 to 7.

FIG. 7 is a sequence diagram illustrating details of the test of ID=T1 in FIG. 6.

Based on the timing clock indicated by the timing line SCK0, the transmission element UBHW0 of the host device 10 transmits the test signal to the device LC0 that is the test target (“first set” in FIG. 3) in the place via the reception line BHW0 (S11A). This test signal is configured as, for example, a 32-bit test data pattern for one line termination unit 20, for example, by a data set in the following order.
(B1) Voice or data (8 bits)
(B2) Voice or data (8 bits)
(D) Data (2 bits)
Dummy data (6 bits)
Control signal (8 bits)

The host device 10 instructs the line termination unit 20 of the transmission destination to loop back a signal via the control signal (8 bits) in the test signal. The line termination unit 20 that has received the instruction responds to the host device 10 with a response signal including at least one of (B1), (B2), and (D) in the test signal.

In a case where at least one of (B1), (B2), and (D) in the transmitted test signal is included in the response signal, the host device 10 determines that the loopback (test) is successful.

Although the 32-bit test data pattern has been exemplified above, arbitrary data such as a random pattern called “PN15” can be used as the test signal.

The device LC0 transmits, as a response signal to S11A, the same signal (loopback signal) as the test signal of S11A from the transmission line FHW0 to the reception element UFHW0 of the host device 10 (S11B).

When the test signal transmitted in S11A and the response signal received in S11B match (Yes in S12), the host device 10 determines that each wiring (the transmission line FHW0, the reception line BHW0, and the timing line SCK0) of the device LC0 is normal, and shifts to a new first test target (the device LC9 of ID=T2 in FIG. 6).

That is, in a case where the normality of the device LC0 is confirmed (Yes in S12), the communication of the test signal by another line termination unit 20 (devices LC8, LC16, LC24, . . . ) connected to the same communication line as the communication line (the transmission line FHW0 and the reception line BHW0) connected to the device LC0 can be omitted.

On the other hand, when the test signal and the response signal do not match (No in S12), the host device 10 sets another device LC8 connected by the same transmission and reception line (the transmission line FHW0 and the reception line BHW0) as the device LC0 as a next test target (“second set” in FIG. 3).

Note that the first test target (device LC0) is mounted on the mounting unit 21 in advance, but the next test target (device LC8) may be mounted on the mounting unit 21 after abnormality of the device LC0 is found (after No in S12). That is, in many cases, since the device LC0 is expected to be normal, the number of times of mounting the device LC8 can be reduced.

Hereinafter, the checking process in which the device LC8 is set as the next test target after No in S12 will be described.

Based on the timing clock indicated by the timing line SCK1, the transmission element UBHW0 of the host device 10 transmits the test signal to the device LC8 via the reception line BHW0 (S21A). The device LC8 transmits a response signal to S21A from the transmission line FHW0 to the reception element UFHW0 of the host device 10 (S21B).

When the test signal transmitted in S21A and the response signal received in S21B match (Yes in S22), the host device 10 determines that the transmission and reception lines (the transmission line FHW0 and the reception line BHW0) are normal and the timing line SCK0 is abnormal.

On the other hand, when the test signal and the response signal do not match (No in S22), the host device 10 determines that the transmission and reception lines (the transmission line FHW0 and the reception line BHW0) are abnormal and the timing line SCK0 is normal.

Strictly speaking, when it is determined that the timing line SCK0 is abnormal in (Yes in S22), the cause thereof may be disconnection of the timing line SCK0 or failure of the timing element USCK0 which is an end point of the timing line SCK0. Therefore, the host device 10 may further narrow down the cause portion by additionally testing the timing element USCK0 in its own device.

Similarly, when it is determined that the transmission and reception lines (the transmission line FHW0 and the reception line BHW0) are abnormal in (No in S22), the host device 10 may further narrow down the cause portion by additionally testing the reception element UFHW0 and the transmission element UBHW0 in its own device.

As described above with reference to FIG. 7, the abnormal portion in the mounting unit 21 can be narrowed down by the number of times of checking once (S12) or twice (S12 and S22) per device LC.

Therefore, the normality of all the transmission lines FHW0 to 7, all the reception lines BHW0 to 7, and all the timing lines SCK0 to 15 can be checked by checking the normal operation of the total of 16 to 32 line termination units 20 of ID=T1 to T16 in FIG. 6. Accordingly, the number of times of checking can be reduced as compared with the case where all (128) line termination units 20 are actually mounted and checked on the mounting unit 21.

### EFFECTS

The present invention provides a subscriber line accommodation device 2 including a mounting unit 21 capable of mounting a plurality of line termination units 20,
the mounting unit 21 includes a communication line for the plurality of line termination units 20 to communicate a test signal with a time difference by a time division multiplex transmission method, and a timing line SCK for causing the plurality of line termination units 20 to receive a communication timing of the test signal in the time division multiplex transmission method, and
the test signal is communicated with at least one line termination unit 20 connected to the same communication line to test normality of the same communication line, and the communication timing is received by at least one line termination unit 20 connected to the same timing line SCK to test normality of the same timing line SCK.

Accordingly, since the normality of the communication line and the normality of the timing line SCK can be tested without actually mounting all the line termination units 20 that can be mounted on the mounting unit 21, it is possible to reduce the burden of the test on the mounting unit 21 of the subscriber line accommodation device 2.

According to the present invention,
the mounting unit 21 determines that the same communication line is normal in a case where normality of a predetermined line termination unit 20 connected to the same communication line is confirmed, and omits communication of a test signal by another line termination unit 20 connected to the same communication line, and
the mounting unit 21 checks normality of the other line termination unit 20 by a test signal communicated by the other line termination unit 20 connected to the same communication line in a case where an abnormality is confirmed in the predetermined line termination unit 20, and regards the same communication line as abnormal in a case where an abnormality is confirmed in the other line termination unit 20.

Accordingly, the abnormal portion can be narrowed down based on the combination information of the line termination unit 20 in which the abnormality is confirmed.

According to the present invention,
the inside of the mounting unit 21 is configured such that the line termination units 20 can be arranged in a lattice shape,
a set of the line termination units 20 to which the same communication line is connected is arranged in one direction of the lattice shape, and
a set of the line termination units 20 to which the same timing line SCK is connected is arranged in the other direction of the lattice shape.

Accordingly, by transmitting and receiving the test signal to and from one line termination unit 20, it is possible to simultaneously check the normality of the communication line connected to the line termination unit 20 and the normality of the timing line. Therefore, the number of tests can be reduced as compared with a method of separately testing the normality of the communication line and the normality of the timing line.

The present invention provides a test system 100 including the subscriber line accommodation device 2 and the line termination unit 20 mounted on the mounting unit 21 of the subscriber line accommodation device 2, and
normality of a communication line is tested by looping back a received test signal using a loopback function of the line termination unit 20 or a loopback function of a subscriber terminal 30 accommodated in the line termination unit 20.

Accordingly, a response signal to the test signal transmitted from the host device 10 to the line termination unit 20 is automatically generated and returned to the host device 10. In addition, in a case where the loopback function of the line termination unit 20 is utilized, it is possible to reduce complicated work of connecting the subscriber terminal 30 to the outside of the subscriber line accommodation device 2.

### REFERENCE SIGNS LIST

2 Subscriber line accommodation device
10 Host device
20 Line termination unit
21 Mounting unit
30 Subscriber terminal
100 Test system
FHW Transmission line (communication line)
BHW Reception line (communication line)
SCK Timing line

1. A subscriber line accommodation device comprising;
a mounting unit, includes one or more processors, configured to mount a plurality of line termination units,
wherein the mounting unit includes a communication line for the plurality of line termination units to communicate a test signal with a time difference by a time division multiplex transmission method, and a timing line for causing the plurality of line termination units to receive a communication timing of the test signal in the time division multiplex transmission method, and
the test signal is communicated with at least one of the line termination units connected to a same communication line to test normality of the same communication line, and the communication timing is received by at least one of the line termination units connected to a same timing line to test normality of the same timing line.

2. The subscriber line accommodation device according to claim 1,
wherein the mounting unit is configured to determine that the same communication line is normal in a case where normality of a predetermined line termination unit connected to the same communication line is confirmed, and omit communication of a test signal by another line termination unit connected to the same communication line, and
the mounting unit is configured to check normality of the other line termination unit by a test signal communicated by the other line termination unit connected to the same communication line in a case where an abnormality is confirmed in the predetermined line termination unit, and regard the same communication line as abnormal in a case where an abnormality is confirmed in the other line termination unit.

3. The subscriber line accommodation device according to claim 1,
wherein an inside of the mounting unit is configured to allow the line termination units to be arranged in a lattice shape,
a set of the line termination units to which the same communication line is connected is arranged in one direction of the lattice shape, and
a set of the line termination units to which the same timing line is connected is arranged in another direction of the lattice shape.

4. A test system comprising a subscriber line accommodation device, the test system comprising:
a mounting unit, includes one or more processors, configured to mount a plurality of line termination units,
wherein the mounting unit includes a communication line for the plurality of line termination units to communicate a test signal with a time difference by a time division multiplex transmission method, and a timing line for causing the plurality of line termination units to receive a communication timing of the test signal in the time division multiplex transmission method,
the test signal is communicated with at least one of the line termination units connected to a same communication line to test normality of the same communication line, and the communication timing is received by at least one of the line termination units connected to a same timing line to test normality of the same timing line; and
the line termination unit mounted on the mounting unit of the subscriber line accommodation device,
wherein normality of a communication line is tested by looping back a received test signal using a loopback function of the line termination unit or a loopback function of a subscriber terminal accommodated in the line termination unit.

5. A test method executed by a subscriber line accommodation device including a mounting unit capable of mounting a plurality of line termination units, the test method comprising:
communicating a test signal with a time different by a time division multiplex transmission method, wherein the mounting unit includes a communication line for the plurality of line termination units;
causing the plurality of line termination units to receive a communication timing of the test signal in the time division multiplex transmission method using a timing line;
communicating the test signal with at least one of the line termination units connected to the same communication line to test normality of the same communication line; and receiving the communication timing by at least one of the line termination units connected to the same timing line to test normality of the same timing line.

6. A test program for causing a computer to function as the subscriber line accommodation device according to claim 1.
